(19) United States
(12) Patent Application Publication
(10) Pub. No.: US 2025/0391038 A1
(43) Pub. Date: Dec. 25, 2025

(54) METHOD FOR ANALYZING BALL GAME MOTION, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Feixiang LU, Beijing (CN); He JIANG, Beijing (CN); Haotian PENG, Beijing (CN); Yihao LV, Beijing (CN); Longteng LI, Beijing (CN)

(21) Appl. No.: 19/314,510

(22) Filed: Aug. 29, 2025

(30) Foreign Application Priority Data
Jun. 20, 2025 (CN) 202510838620.0

(51) Int. Cl. G06T 7/246; G06T 7/73; G06V 20/40; G06V 40/20

(52) U.S. Cl. CPC G06T 7/251; G06T 7/75; G06V 20/40; G06V 40/23; G06T 2207/10016; G06T 2207/20212; G06T 2207/30196; G06T 2207/30224; G06T 2207/30241

(57) ABSTRACT

A method for analyzing a ball game motion includes: in response to entering a serving stage, obtaining a motion trajectory of a ball by fitting based on a ball game video acquired; determining a hitting coordinate of a motion subject, a hitting posture of the motion subject, and a landing coordinate of the ball based on the motion trajectory and the ball game video; and obtaining a motion analysis result based on the hitting coordinate, the hitting posture, and the landing coordinate, to display the motion analysis result in real time through a display device.

### CROSS-REFERENCE TO RELATED APPLICATION(S)

This application claims the benefit of Chinese Patent Application No. 202510838620.0 filed on Jun. 20, 2025, the whole disclosure of which is incorporated herein by reference.

### TECHNICAL FIELD

The present disclosure relates to the field of artificial intelligence technology, and more particularly, to the fields of computer vision, deep neural networks, and motion analysis technologies.

### BACKGROUND

In current sports competition scenarios, driven by athletes' continuous pursuit of improving sports performance, there is an increasing demand for high-precision and real-time motion performance analysis. Motion performance analysis may include precise interpretation of technical details, real-time adjustment of sports strategies, and effective implementation of injury prevention. Traditional analysis methods typically rely on manual observation and post-event data processing, which are inefficient and difficult to meet the requirements for precision and real-time performance.

### SUMMARY

The present disclosure provides a method for a ball game motion, an electronic device, and a storage medium.

According to an aspect of the present disclosure, a method for analyzing a ball game motion is provided, including: in response to entering a serving stage, obtaining a motion trajectory of a ball by fitting based on a ball game video acquired; determining a hitting coordinate of a motion subject, a hitting posture of the motion subject, and a landing coordinate of the ball based on the motion trajectory and the ball game video; and obtaining a motion analysis result based on the hitting coordinate, the hitting posture, and the landing coordinate, to display the motion analysis result in real time through a display device.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method described above.

According to another aspect of the present disclosure, a non-transitory computer-readable storage medium having computer instructions therein is provided, and the computer instructions are configured to cause a computer to implement the method described above.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute any limitation to the present disclosure. In the accompanying drawings:

FIG. 1 schematically shows an exemplary system architecture to which a method and apparatus for analyzing a ball game motion according to an embodiment of the present disclosure may be applied;

FIG. 2 schematically shows a flowchart of a method for analyzing a ball game motion according to an embodiment of the present disclosure;

FIG. 3 schematically shows a schematic diagram of capturing videos using cameras according to an embodiment of the present disclosure;

FIG. 4A schematically shows a schematic diagram of determining a fitted ball coordinate of a video frame according to an embodiment of the present disclosure;

FIG. 4B schematically shows a schematic diagram of determining a fitted ball coordinate of a video frame according to an embodiment of the present disclosure;

FIG. 5 schematically shows a schematic diagram of a motion trajectory according to an embodiment of the present disclosure;

FIG. 6 schematically shows a schematic diagram of a method for analyzing a ball game motion according to an embodiment of the present disclosure;

FIG. 7 schematically shows a block diagram of an apparatus for analyzing a ball game motion according to an embodiment of the present disclosure; and

FIG. 8 shows a schematic block diagram of an example electronic device that may be used to implement the embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

Embodiments of the present disclosure provide a method and apparatus for analyzing a ball game motion, an electronic device, and a storage medium, which are intended to at least partially solve the problems existing in traditional motion analysis and recording methods. By employing advanced computer vision and artificial intelligence technologies, it is possible to accurately capture and analyze athletes' actions in real time. Through automated recording of motion performance, it is possible to reduce the dependence on manual operation, thereby improving the consistency and objectivity of data acquisition. In addition, by rapidly processing and analyzing data, it is possible to provide immediate feedback for coaches and athletes, thereby optimizing training and competition strategies.

Furthermore, embodiments of the present disclosure may be applied not only to the field of professional sports to assist coaches and athletes in analyzing and improving performance, but also to school sports and amateur sports activities to provide technical support for athletes' training and competitions. Alternatively, embodiments of the present disclosure may also be integrated into sports technology products, such as smart fitness equipment and sports performance analysis software, to provide scientific and precise motion analysis services for public users.

Specifically, the method for analyzing a ball game motion provided by embodiments of the present disclosure includes: in response to entering a serving stage, obtaining a motion trajectory of a ball by fitting based on a ball game video acquired; determining a hitting coordinate of a motion subject, a hitting posture of the motion subject, and a landing coordinate of the ball based on the motion trajectory and the ball game video; and obtaining a motion analysis result based on the hitting coordinate, the hitting posture, and the landing coordinate, to display the motion analysis result in real time through a display device.

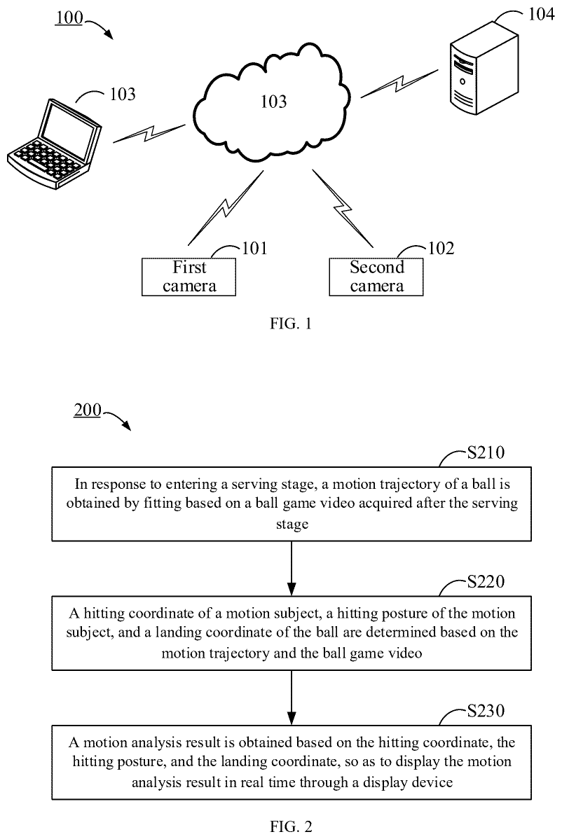

FIG. 1 schematically shows an exemplary system architecture to which a method and apparatus for analyzing a ball game motion according to an embodiment of the present disclosure may be applied.

It should be noted that FIG. 1 is merely an example of the system architecture to which embodiments of the present disclosure may be applied, to help those skilled in the art understand technical contents of the present disclosure. However, it does not mean that embodiments of the present disclosure may not be applied to other devices, systems, environments or scenarios. For example, in another embodiment, the exemplary system architecture to which a method and apparatus for analyzing a ball game motion may be applied may include a terminal device, but the terminal device may implement the method and apparatus for analyzing a ball game motion without interacting with a server.

As shown in FIG. 1, a system architecture 100 according to this embodiment may include a first camera 101, a second camera 102, a terminal device 103, a network 104, and a server 105. The network 104 is used to provide a medium for communication links between the first camera 101, the second camera 102, the terminal device 103, and the server 105. The network 104 may include various types of connections, such as wired and/or wireless communication links, and the like.

The first camera 101 and the second camera 102 may be arranged on a side of a playing field, and a combined field of view of the first camera 101 and the second camera 102 may cover the playing field.

The terminal device 103 may be any type of electronic device having a display screen, including but not limited to a smartphone, a tablet computer, a laptop computer, and a desktop computer.

The server 105 may be a server providing various services, including a GPU server, an AI server, and a cloud server.

It should be noted that the method for analyzing a ball game motion provided by embodiments of the present disclosure may generally be performed by the terminal device 103. Accordingly, the apparatus for analyzing a ball game motion provided by embodiments of the present disclosure may generally be disposed in the terminal device 103.

Alternatively, the method for analyzing a ball game motion provided by embodiments of the present disclosure may generally be performed by the server 105. Accordingly, the apparatus for analyzing a ball game motion provided by embodiments of the present disclosure may generally be disposed in the server 105. The method for analyzing a ball game motion provided by embodiments of the present disclosure may also be performed by a server or server cluster different from the server 105 and capable of communicating with the terminal device 103 and/or the server 105. Accordingly, the apparatus for analyzing a ball game motion provided by embodiments of the present disclosure may also be disposed in a server or server cluster different from the server 105 and capable of communicating with the terminal device 103 and/or the server 105.

It should be understood that the numbers of cameras, terminal devices, networks, and servers in FIG. 1 are merely illustrative. According to implementation needs, any number of cameras, terminal devices, networks, and servers may be provided.

In the technical solutions of the present disclosure, the collection, storage, use, processing, transmission, provision, disclosure, application, and other processing of user personal information involved all comply with relevant laws and regulations, take necessary confidentiality measures, and do not violate public order and good customs.

In the technical solutions of the present disclosure, the acquisition or collection of user personal information has been authorized or allowed by users.

FIG. 2 schematically shows a flowchart of a method for analyzing a ball game motion according to an embodiment of the present disclosure.

As shown in FIG. 2, a method 200 includes operation S210 to operation S230.

In operation S210, in response to entering a serving stage, a motion trajectory of a ball is obtained by fitting based on a ball game video acquired after the serving stage.

In operation S220, a hitting coordinate of a motion subject, a hitting posture of the motion subject, and a landing coordinate of the ball are determined based on the motion trajectory and the ball game video.

In operation S230, a motion analysis result is obtained based on the hitting coordinate, the hitting posture, and the landing coordinate, to display the motion analysis result in real time through a display device.

The method for analyzing a ball game motion according to embodiments of the present disclosure may be applied to motion analysis of any net-separated competitive ball game, which may include, for example, tennis, badminton, table tennis, and the like.

The serving stage may refer to a beginning stage of each rally in a ball game. Accordingly, the ball game video may refer to a video of the rally corresponding to the serving stage. By identifying the serving stage, a ball game video for each rally may be acquired separately, and the motion analysis may be performed on each rally based on the ball game video for that rally. For example, differences in technical details of the motion subject across different rallies may be analyzed. Alternatively, the serving stage may also refer to a beginning stage of an entire ball game. Accordingly, the ball game video may refer to a continuously acquired video corresponding to the entire ball game.

The ball may refer to an object being hit in the ball game. For example, in tennis, the ball may be a tennis ball; in badminton, the ball may be a shuttlecock, and so on.

The motion trajectory of the ball may refer to a trajectory of a point representing the ball in a video coordinate system of the ball game video. Any point of the ball may be used as the point representing the ball in the video coordinate system. For example, a center point of the ball may be used as the point representing the ball in the video coordinate system. A position of the camera used to capture the ball game video may be fixed. Therefore, the video coordinate system of the ball game video may be consistent with an image coordinate system of each video frame of the ball game video.

Both the hitting coordinate and the landing coordinate may be coordinate points in the ball game video. The hitting coordinate may refer to a coordinate position of the ball in the ball game video when the motion subject hits the ball. The landing coordinate may refer to a coordinate position of the ball in the ball game video when the ball lands on the ground for the first time after crossing the net. Optionally, the landing coordinate may further include coordinate positions of the ball in the ball game video when the ball lands on the ground for the second time or more after crossing the net. The landing coordinate may also be used to determine the win or loss of the motion subject in the rally.

The hitting posture of the motion subject may include a posture of the motion subject during preparation before hitting the ball, a posture of the motion subject during the hitting, a posture of the motion subject maintained after the hitting, and the like. Optionally, the hitting posture of the motion subject may be represented as an extracted segment of continuous action of the motion subject. Alternatively, through action recognition and classification, a segment of continuous action of the motion subject may be classified into any one of a plurality of predetermined motion postures. The predetermined motion posture obtained by classification may represent the hitting posture of the motion subject.

Optionally, during motion analysis, the hitting coordinate, the landing coordinate and the like in the ball game video may be transformed into information corresponding to hitting position, landing position and the like in the playing field, so that the motion subject or a coach may acquire a motion analysis information more intuitively.

The motion analysis result may be displayed in real time through a display device by way of real-time feedback. Optionally, while displaying the motion analysis result, the ball game video may be displayed simultaneously, to provide technical support for the training and competition of the motion subject.

According to an embodiment of the present disclosure, after the serving stage has begun, through real-time capture of the ball game video, a motion trajectory of the ball may be obtained by fitting. Based on the motion trajectory, the hitting coordinate of the motion subject, the hitting posture of the motion subject, and the landing coordinate of the ball may be obtained by analyzing the ball game video, and the motion analysis result obtained based on the hitting coordinate of the motion subject, the hitting posture of the motion subject, and the landing coordinate of the ball may be displayed in real time, thereby improving the efficiency and real-time performance of the motion analysis.

The method shown in FIG. 2 will be further described below with reference to the accompanying drawings and specific embodiments.

The ball game video may be captured by a camera. Optionally, due to the limitation of a camera field of view, the field of view of a single camera may not cover the entire playing field. In this case, it is possible to provide a plurality of cameras at the same position, and acquire a ball game video covering the entire playing field by combining the videos respectively captured by the plurality of cameras.

For example, a ball game video may be obtained based on the videos respectively captured by the plurality of cameras, where a target field of view covering the playing field is obtained by combining the fields of view of the plurality of cameras.

The plurality of cameras may be fixedly arranged on a side of the playing field and parallel to a horizontal plane of the playing field, so that the images captured by the cameras are substantially horizontal. Optionally, it is possible to adjust angles of the cameras so that only one playing field is contained in the video images captured by the cameras.

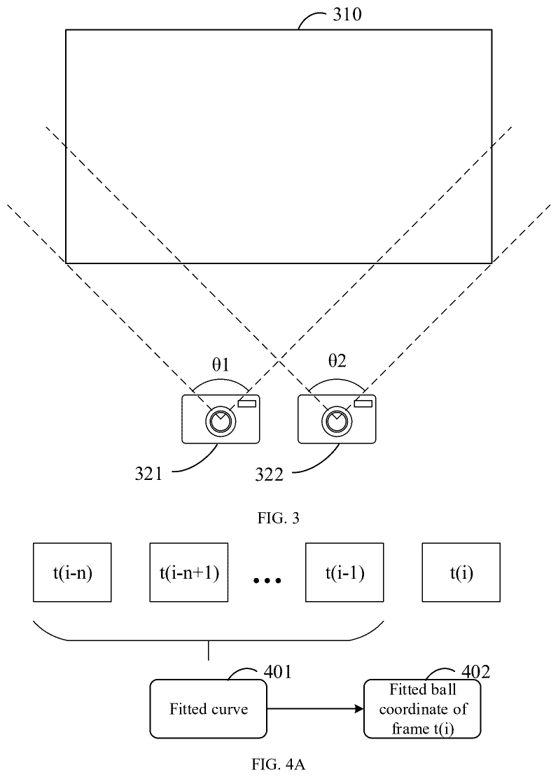

FIG. 3 schematically shows a schematic diagram of capturing videos using cameras according to an embodiment of the present disclosure.

As shown in FIG. 3, a first camera 321 and a second camera 322 may be arranged adjacent to each other on a side of the playing field 310. The first camera 321 has a field of view angle θ₁, and the field of view of the first camera 321 may cover a first region 311 of the playing field 310. The second camera 322 has a field of view angle θ₂, and the field of view of the second camera 322 may cover a second region 312 of the playing field 310. An overlapping region exists between the first region 311 and the second region 312, and neither the first region 311 nor the second region 312 can independently cover the playing field 310. Accordingly, an image of the video captured solely by the first camera 321 or an image of the video captured solely by the second camera 322 cannot contain the entire playing field 310. Therefore, it is possible to stitch the videos respectively captured by the first camera 321 and the second camera 322 to obtain the ball game video. A target field of view angle represented by the ball game video may be a combination of the field of view angle θ₁ of the first camera 321 and the field of view angle θ₂ of the second camera 322.

Optionally, a stitching process of the videos respectively captured by the plurality of cameras may be determined based on an image capture quality of each camera.

For example, if the plurality of cameras fail to be triggered synchronously and the video frames captured by the cameras contain distortion, then obtaining the ball game video based on the videos respectively captured by the plurality of cameras may include the following operations: acquiring a plurality of first videos respectively captured by the plurality of cameras; performing a timestamp alignment on the plurality of first videos to obtain a plurality of second videos; performing a distortion correction on the plurality of second videos to obtain a plurality of third videos; performing a calibration on the plurality of third videos based on respective extrinsic parameters of the plurality of cameras using an intersection point of boundary lines of the playing field as a calibration target, to obtain a plurality of fourth videos; and stitching the plurality of fourth videos to obtain the ball game video.

When performing the timestamp alignment, it is possible to select a reference timestamp, and remove video content prior to the reference timestamp from each first video, to obtain a plurality of second videos.

The types of distortion that may exist in the second videos may include radial distortion, tangential distortion, prism distortion, and the like. The second videos may be corrected using methods such as camera calibration, geometric constraint-based correction, or deep learning-based correction, to obtain the third videos.

The extrinsic parameters of the camera may include a 3×3 rotation matrix and a 1×3 translation matrix. By using the extrinsic parameters of the camera, a feature point present in all video frames captured by different cameras, such as the intersection point of boundary lines of the playing field, may be used as a calibration target, and the video frames captured by different cameras may be mapped to the same coordinate system to obtain the fourth videos.

After the plurality of fourth videos in the same coordinate system are obtained, the plurality of fourth videos may be stitched to obtain the ball game video. During stitching, duplicate processing may be performed on overlapping portions of the plurality of fourth videos, which is not limited here.

For another example, the plurality of cameras may be triggered synchronously by hardware. In this case, the videos captured by different cameras may be regarded as synchronously acquired. If the video frames captured by the cameras contain distortion, then obtaining the ball game video based on the videos respectively captured by the plurality of cameras may include the following operations: acquiring a plurality of first videos respectively captured by the plurality of cameras; performing a distortion correction on the plurality of first videos to obtain a plurality of third videos; performing a calibration on the plurality of third videos based on the respective extrinsic parameters of the plurality of cameras using the intersection point of boundary lines of the playing field as a calibration target, to obtain a plurality of fourth videos; and stitching the plurality of fourth videos to obtain the ball game video.

For another example, if the plurality of cameras are triggered synchronously by hardware and the video frames captured by the cameras contain no distortion, then obtaining the ball game video based on the videos respectively captured by the plurality of cameras may include the following operations: acquiring a plurality of first videos respectively captured by the plurality of cameras; performing a calibration on the plurality of first videos based on respective extrinsic parameters of the plurality of cameras using the intersection point of boundary lines of the playing field as a calibration target, to obtain a plurality of fourth videos; and stitching the plurality of fourth videos to obtain the ball game video.

Optionally, during extrinsic calibration of the cameras, a transformation matrix for mapping points in the ball game video to points in the playing field may be determined by way of homography transformation based on some feature points in the playing field.

For example, a first position of the intersection point of boundary lines in the playing field and a second position of the intersection point of boundary lines in the ball game video may be determined, and a homography transformation may be performed based on the first position and the second position, to obtain the transformation matrix.

By using this transformation matrix, mapping from points in the ball game video to points in the playing field may be achieved. For example, during motion analysis, the hitting coordinate and the landing coordinate may be mapped to the playing field based on the transformation matrix to obtain the hitting position of the motion subject and the landing position of the ball. Further, a statistical analysis may be performed based on the hitting position, the hitting posture, and the landing position to obtain a motion analysis result. In this way, the hitting coordinate and the landing coordinate may be mapped to the hitting position and the landing position in the actual sports scenario, thereby effectively improving the readability of the motion analysis result and facilitating the motion analysis by a coach.

Optionally, before entering the serving stage, an initial motion video may be obtained based on the videos respectively captured by the plurality of cameras. The operation of obtaining the initial motion video based on the videos respectively captured by the plurality of cameras may be similar to the operation of obtaining the ball game video based on the videos respectively captured by the plurality of cameras, which will not be repeated here. Optionally, the serving stage may be used as a separation point, such that the videos captured by the cameras before the serving stage may form the initial motion video, and the videos captured by the cameras after entering the serving stage may form the ball game video.

Optionally, a stage detection may be performed based on the initial motion video to obtain a detection result. The detection result is used to indicate whether the serving stage has begun.

Whether the serving stage has begun may be determined based on the rules of the ball game. For example, in tennis, the server is required to serve in a designated serving region and must hit the tennis ball into a designated region. Accordingly, the receiver may stand in another designated region in preparation to return the serve. Therefore, in the captured video, if it is determined that the server remains relatively stationary in the serving region and the receiver remains relatively stationary in the other designated region, it may be determined that the serving stage has begun.

According to an embodiment of the present disclosure, performing a stage detection based on the initial motion video to obtain a detection result may include the following operations: performing an object detection on the initial motion video to obtain a second bounding box of the motion subject in the initial motion video; obtaining an image coordinate of the motion subject based on a center point of a bottom surface of the second bounding box; mapping the image coordinate of the motion subject to the playing field based on the transformation matrix to obtain a position information of the motion subject, where the position information of the motion subject includes a first position information of a serving motion subject and a second position information of a receiving motion subject; and obtaining a detection result indicating that the serving stage has begun if, in a plurality of consecutive third target video frames included in the initial motion video, each first position information indicates a position in the serving region of the playing field and each second position information indicates a position in the receiving region of the playing field.

In an object detection task, a bounding box may be represented as a rectangular box closely surrounding a target object, which is used to locate and identify the detected target object in a video frame. Accordingly, by performing an object detection on each video frame of the initial motion video, the motion subject may be located and identified in each video frame using the second bounding box.

In each video frame of the initial motion video, a center point of a bottom surface of the second bounding box identified in the video frame may be taken as the image coordinate of the motion subject in the video frame.

Optionally, the cameras may be arranged on the side of the playing field to capture videos, and it is difficult to intuitively determine the actual position of the motion subject in the playing field based on the image coordinate of the motion subject in the video frame. Therefore, it is possible to map the image coordinate of the motion subject in each video frame of the initial motion video to the playing field using the transformation matrix, to obtain the position information of the motion subject in the playing field at a plurality of consecutive time instants. In a ball game, the motion subject may include at least a serving motion subject and a receiving motion subject. Accordingly, the position information of the motion subject in the playing field at each time instant may include a first position information of the serving motion subject and a second position information of the receiving motion subject.

A period including a plurality of time instants may be arbitrarily intercepted from the plurality of consecutive time instants, and the plurality of time instants in the period may correspond to a plurality of consecutive third target video frames included in the initial motion video. In a case where, at the plurality of time instants in the period, the plurality of first position information of the serving motion subject are all located in the serving region of the playing field, and the plurality of second position information of the receiving motion subject are all located in the receiving region of the playing field, it may be determined that the current stage is a serving stage or a stage of preparing to serve.

If it is determined that the serving stage has begun, a ball game video may be captured by a plurality of cameras. For the plurality of video frames included in the ball game video, the coordinate of the ball in each video frame of the ball game video may be corrected frame by frame, and a motion trajectory may be obtained by fitting based on the corrected coordinates. Specifically, a position correction may be performed on an initial ball coordinate of the video frame to obtain a target ball coordinate of the video frame, and a curve fitting may be performed based on the target ball coordinates of the plurality of video frames to obtain the motion trajectory of the ball.

In each video frame, an image area occupied by the ball is generally larger than an area that may be represented by a single coordinate point. Optionally, in order to simplify calculation, a center point of a bounding box of the ball may be used as a feature point of the ball. Accordingly, a coordinate of the center point of the bounding box of the ball may be used as the initial ball coordinate of the video frame.

Specifically, an object detection may be performed on the video frame to obtain a first bounding box in the video frame; and the initial ball coordinate of the video frame may be obtained based on the center point of the first bounding box.

The first bounding box may be represented as a rectangular box, and the center point of the first bounding box may be represented as a geometric center point of the corresponding rectangular box.

Performing a position correction on the initial ball coordinate of each video frame may include detecting whether a false detection or a missed detection occurs in the video frame. In a case of a false detection or a missed detection, the position of the ball in the video frame may be re-determined, to determine a target ball coordinate of the video frame. A false detection may refer to a case in which an object other than the ball is misidentified as the ball, and the ball is not accurately detected, that is, the detected bounding box in the video frame contains an object other than the ball. A missed detection may refer to a case in which no bounding box representing a detected object is obtained after the object detection is performed on the video frame, that is, no object in the video frame is detected. Optionally, in a case of a missed detection in the video frame, a predetermined coordinate may be determined as the initial ball coordinate of the video frame, and the predetermined coordinate may be at a large distance from the coordinate of a point on a normal motion trajectory.

Optionally, when performing a position correction on the initial ball coordinate in the video frame, a coordinate position of the video frame may be obtained by fitting according to some other video frames associated with the video frame. One of the initial ball coordinate and the fitted coordinate position of the video frame may be selected as the corrected target ball coordinate of the video frame according to a determination result of whether a missed detection, a false detection or other phenomenon has occurred.

According to an embodiment of the present disclosure, performing a position correction on the initial ball coordinate of the video frame to obtain the target ball coordinate of the video frame may include the following operations: determining a plurality of first target video frames associated with the video frame from the ball game video; determining a fitted ball coordinate of the video frame based on the respective ball coordinates of the plurality of first target video frames, where the ball coordinate of the first target video frame includes an initial ball coordinate or a target ball coordinate of the first target video frame; and obtaining the target ball coordinate of the video frame based on the fitted ball coordinate and the initial ball coordinate of the video frame.

When determining the fitted ball coordinate of the video frame based on the respective ball coordinates of the plurality of first target video frames, if the first target video frame has not undergone position correction, the initial ball coordinate of the first target video frame may be used to determine the fitted ball coordinate of the video frame; if the first target video frame has undergone position correction, the target ball coordinate of the first target video frame may be used to determine the fitted ball coordinate of the video frame.

Since the motion trajectory of the ball may be regarded as a parabola, a fitted curve may be determined by means of quadratic curve fitting, and then the fitted curve may be extended backward or forward to obtain the fitted ball coordinate of the video frame.

According to an embodiment of the present disclosure, determining the fitted ball coordinate of the video frame based on the respective ball coordinates of the plurality of first target video frames may include the following operations: performing a quadratic curve fitting based on the respective ball coordinates of the plurality of first target video frames to obtain a fitted curve; and determining the fitted ball coordinate of the video frame based on the fitted curve.

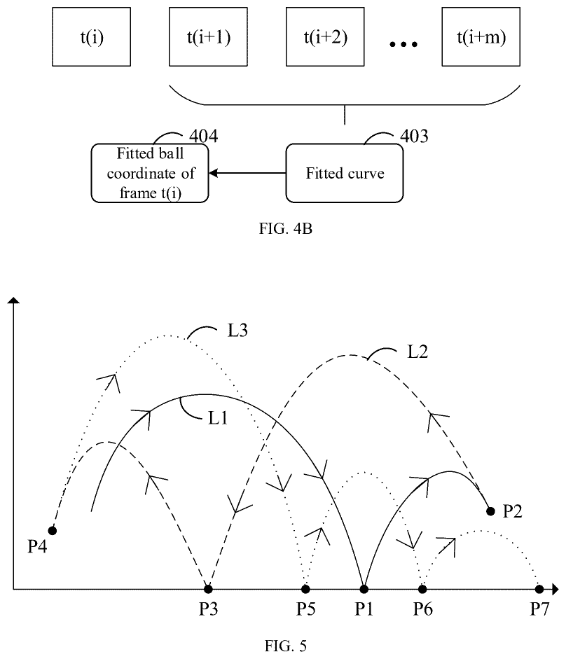

FIG. 4A schematically shows a schematic diagram of determining a fitted ball coordinate of a video frame according to an embodiment of the present disclosure.

As shown in FIG. 4A, the video frame may be frame t(i) of the ball game video, and a first predetermined number of video frames preceding the video frame may be selected from the ball game video to obtain a plurality of first target video frames. If the first predetermined number is n, frame t(i−n), frame t(i−n+1), . . . , frame t(i−1) of the ball game video may be selected as the plurality of first target video frames associated with the frame t(i) of the ball game video. A frame-by-frame correction of the ball game video may be performed in chronological order, so the frame t(i−n), frame t(i−n+1), . . . , frame t(i−1) may be corrected video frames. Therefore, a quadratic curve fitting may be performed based on the respective target ball coordinates of the frame t(i−n), frame t(i−n+1), . . . , frame t(i−1) to obtain a fitted curve 401. The fitted curve 401 may be, for example, expressed as y=a₁x²+b₁. By extending the fitted curve 401 forward, a fitted ball coordinate 402 of the frame t(i) may be obtained, and the fitted ball coordinate 402 may be expressed as (i,a₁i²+b₁).

FIG. 4B schematically shows a schematic diagram of determining a fitted ball coordinate of a video frame according to an embodiment of the present disclosure.

As shown in FIG. 4B, the video frame may be frame t(i) of the ball game video, and a second predetermined number of video frames subsequent to the video frame may be selected from the ball game video to obtain a plurality of first target video frames. If the second predetermined number is m, frame t(i+1), frame t(i+2), . . . , frame t(i+m) of the ball game video may be selected as the plurality of first target video frames associated with the frame t(i) of the ball game video. The frame-by-frame correction of the ball game video may be performed in chronological order, such that the frame t(i+1), frame t(i+2), . . . , frame t(i+m) may be uncorrected video frames. Therefore, a quadratic curve fitting may be performed using respective initial ball coordinates of the frame t(i+1), frame t(i+2), . . . , frame t(i+m) to obtain a fitted curve 403. The fitted curve 403 may be, for example, represented as y=a₂x²+b₂. By extending the fitted curve 403 backward, a fitted ball coordinate 404 of the frame t(i) may be obtained, and the fitted ball coordinate 404 may be expressed as (i,a₂i²+b₂).

Optionally, in the above embodiments, preceding or subsequent to the video frame may refer to being positioned before or after the video frame in chronological order.

Optionally, the ball coordinate of a current video frame may be compared with the ball coordinate of a previous video frame of the current video frame. If a distance between the ball coordinate of the current video frame and the ball coordinate of the previous video frame is excessively large, it may be determined that a false detection has occurred in the current video frame. In such a case, the fitted ball coordinate may be adopted as an accurate coordinate.

According to an embodiment of the present disclosure, obtaining the target ball coordinate of the video frame based on the fitted ball coordinate and the initial ball coordinate of the video frame may include the following operations: calculating a distance between the initial ball coordinate of the video frame and the target ball coordinate of an adjacent video frame to obtain a first distance, where the adjacent video frame is a previous video frame of the video frame in the ball game video; and determining the fitted ball coordinate of the video frame as the target ball coordinate of the video frame if the first distance is greater than a first predetermined threshold.

The first predetermined threshold may be determined according to an average flight speed of the ball and a frame rate of the camera. Optionally, it is possible to determine a distance in the playing field based on the average flight speed of the ball and the frame rate of the camera, and then map the distance in the playing field to the video frame to obtain the first predetermined threshold, which is not limited here.

The speed of the ball may be considered approximately constant. Accordingly, a distance traveled by the ball between two adjacent frames, especially a distance traveled by the ball in a horizontal direction, may be substantially equal. Therefore, if the first distance between the ball coordinates in two adjacent video frames is greater than the first predetermined threshold, it may be determined that the object represented by the first bounding box detected in the video frame is not the ball, that is, a false detection occurs in the video frame. In a case of a false detection, the fitted ball coordinate may be adopted as an accurate coordinate.

Optionally, since the motion trajectory of the ball generally exhibits regularity, if there is a large discrepancy between the fitted ball coordinate obtained based on other video frames and the initial ball coordinate of the video frame, it may be determined that a false detection occurs in the video frame, and the fitted ball coordinate may be adopted as an accurate coordinate.

According to an embodiment of the present disclosure, obtaining the target ball coordinate of the video frame based on the fitted ball coordinate and the initial ball coordinate of the video frame may include the following operations: calculating a distance between the fitted ball coordinate of the video frame and the initial ball coordinate of the video frame to obtain a second distance; and determining the fitted ball coordinate of the video frame as the target ball coordinate of the video frame if the second distance is greater than a second predetermined threshold.

According to embodiments of the present disclosure, by performing frame-by-frame correction on the ball game video and obtaining the motion trajectory of the ball by fitting using the corrected ball game video, the accuracy of the fitted motion trajectory may be effectively improved, thereby enhancing the accuracy of subsequent hitting coordinate and landing coordinate, and further improving the accuracy of the motion analysis result.

Based on the rules of ball games, after one party hits the ball, the other party needs to wait for the ball to land and bounce before returning the ball. Therefore, the hitting coordinate and the landing coordinate may be determined based on trough positions of the motion trajectory. When determining the hitting coordinate, a hitting time instant may be determined accordingly, and a hitting posture of the motion subject may then be extracted from the video based on the hitting time instant.

According to an embodiment of the present disclosure, determining the hitting coordinate of the motion subject, the hitting posture of the motion subject, and the landing coordinate of the ball based on the motion trajectory and the ball game video may include the following operations: determining the hitting coordinate of the motion subject and the landing coordinate of the ball based on trough positions of the motion trajectory; and determining the hitting posture of the motion subject from the ball game video based on a hitting time information corresponding to the hitting coordinate.

The motion trajectory may be represented as a function curve, where a horizontal axis of the function curve may represent a horizontal displacement of the ball in the ball game video, and a vertical axis may represent a vertical displacement of the ball in the ball game video. Accordingly, the trough position of the motion trajectory may be represented as a minimum point in the function curve.

Optionally, a plurality of trough positions may exist in a motion trajectory. In such a case, the landing coordinate of the ball may be determined based on a position information of a first trough of the motion trajectory, and the hitting coordinate of the motion subject may be determined based on a position information of a second trough of the motion trajectory.

Optionally, the motion trajectory may include a plurality of function curves, each of which may represent a trajectory segment of the motion trajectory. Adjacent trajectory segments may have different trajectory extension directions. Therefore, the motion trajectory may be divided into a plurality of trajectory segments based on the trajectory extension direction information of the motion trajectory, and each trajectory segment may represent a trajectory formed from one motion subject hitting the ball to another motion subject returning the ball. In such a case, the landing coordinate of the ball may be determined based on the position information of the first trough of the trajectory segment, and the hitting coordinate of the motion subject may be determined based on the position information of the second trough of the trajectory segment.

FIG. 5 schematically shows a schematic diagram of a motion trajectory according to an embodiment of the present disclosure.

As shown in FIG. 5, the motion trajectory may represent a trajectory of the ball during a rally. Arrows on the motion trajectory may represent the trajectory extension directions of the motion trajectory. Based on difference trajectory extension directions, the motion trajectory may be divided into trajectory segment L1, trajectory segment L2, and trajectory segment L3. In FIG. 5, a curve formed by a solid line represents the trajectory segment L1, a curve formed by a dashed line represents the trajectory segment L2, and a curve formed by a dotted line represents the trajectory segment L3.

A starting position of the trajectory segment L1 may represent the serving position, a peak position may approximately represent a net-crossing position, a first trough position subsequent to the net-crossing position may represent a landing coordinate P1, and a second trough position subsequent to the net-crossing position may represent a hitting coordinate P2.

Accordingly, the hitting coordinate P2 may be represented as a starting position of the trajectory segment L2, a peak position of the trajectory segment L2 may approximately represent a net-crossing position, a first trough position subsequent to the net-crossing position may represent a landing coordinate P3, and a second trough position subsequent to the net-crossing position may represent a hitting coordinate P4.

Similarly, the hitting coordinate P4 may be represented as a starting position of the trajectory segment L3, a peak position of the trajectory segment L3 may approximately represent a net-crossing position, a first trough position subsequent to the net-crossing position may represent a landing coordinate P5, and a second trough position subsequent to the net-crossing position may represent a hitting coordinate P6. Moreover, the trajectory segment L3 further includes more trough positions subsequent to the net-crossing position, and such more trough positions may also be regarded as landing coordinates of the trajectory segment. For example, a third trough position may represent a landing coordinate P7. When the landing coordinate P7 appears, it may be determined that the motion subject fails to hit the ball effectively, and the current rally ends.

Optionally, after the hitting coordinate is determined, the hitting posture of the motion subject at the hitting coordinate may be further determined from the ball game video.

According to an embodiment of the present disclosure, determining the hitting posture of the motion subject from the ball game video based on the hitting time information corresponding to the hitting coordinate may include the following operations: determining a plurality of second target video frames from the ball game video based on the hitting time information corresponding to the hitting coordinate; and determining the hitting posture of the motion subject based on the plurality of second target video frames.

Each video frame of the ball game video may be configured with corresponding timestamp information. By comparing the timestamp information of each video frame with the hitting time information corresponding to the hitting coordinate, the video frame corresponding to the hitting time information may be determined. Subsequently, a plurality of consecutive video frames including the video frame may be selected as the plurality of second target video frames. For example, n frames before and after the video frame may be selected as the plurality of second target video frames.

An implementation for determining the hitting posture of the motion subject based on the plurality of second target video frames is not limited here.

For example, it is possible to perform a posture classification and determination using a model. Specifically, the plurality of second target video frames may be input into a human posture detection model. The human posture detection model may be used to detect a plurality of joint key points of the motion subject contained in the plurality of second target video frames, thereby obtaining a detection result. Based on the detection result, an action category to which a current posture of the motion subject belongs may be determined, thereby obtaining the hitting posture of the motion subject.

The human posture detection model may be a trained end-to-end action detection model, which may output an action detection result based on a dynamic information of a plurality of joint key points of the motion subject in the input second target video frames. The human posture detection model may be configured with a corresponding classification model, which may map the action detection result to an action category. By inputting the action detection result into the classification model, a corresponding action category may be obtained, and an action represented by the corresponding action category may be taken as the hitting posture of the motion subject.

For another example, the posture classification and determination may be performed by means of key point trajectory comparison. Specifically, a plurality of joint key point trajectories may be generated based on the plurality of joint key points of the motion subject contained in the plurality of second target video frames; an action model may be constructed based on the plurality of joint key point trajectories; the action model may be compared with respective reference action models of a plurality of action categories to obtain comparison results; and the action category to which the current posture of the motion subject belongs may be determined based on the comparison results, to obtain the hitting posture of the motion subject.

Optionally, each joint key point trajectory may be compared with a trajectory of the corresponding joint key point in the reference action model. The comparison result between the action model and the reference action model may be expressed as a vector, and each element of the vector may represent a similarity between trajectories of a joint key point. For example, if the number of joint key points is 10, the comparison result between the action model and the reference action model of action category A may be expressed as (a1, a2, . . . , a10).

The action model may be compared with each of the plurality of reference action models to obtain a plurality of comparison results. By comparing the plurality of comparison results, the reference action model closest to the action model may be determined. Based on the action category to which the reference action model closest to the action model belongs, the hitting posture of the motion subject may be determined. Each comparison result may be expressed as a vector. When comparing the magnitudes between the plurality of comparison results, it is possible to calculate an L2 norm of each comparison result, and determine the reference action model corresponding to the comparison result with the maximum L2 norm as the reference action model closest to the action model.

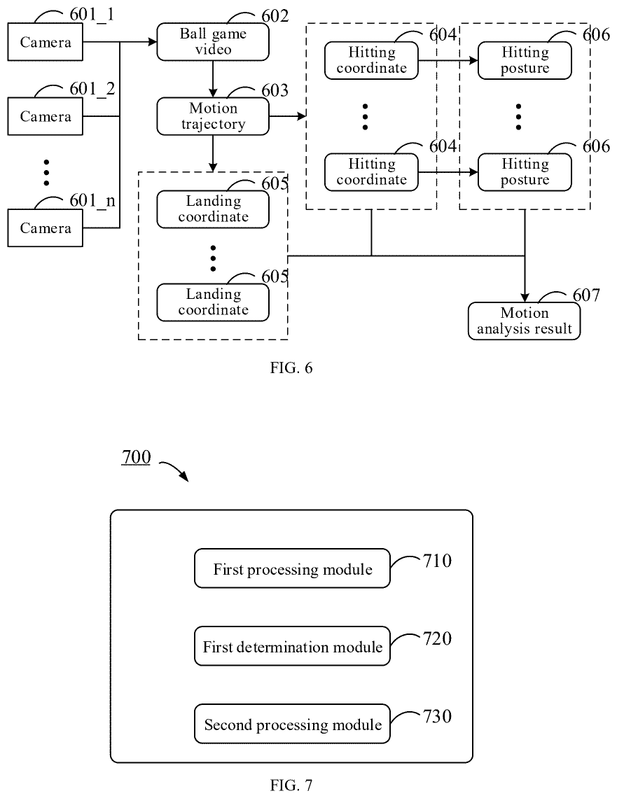

FIG. 6 schematically shows a schematic diagram of a method for analyzing a ball game motion according to an embodiment of the present disclosure.

As shown in FIG. 6, videos respectively captured by a plurality of cameras, including camera 601_1, camera 601_2, . . . , camera 601_n, may be processed to form a ball game video 602. After frame-by-frame correction of the ball coordinates in the ball game video 602, a curve fitting may be performed using a plurality of corrected ball coordinates to obtain a motion trajectory 603 of the ball. By extracting trough positions of the motion trajectory 603, at least one hitting coordinate 604 and at least one landing coordinate 605 may be obtained. For each hitting coordinate 604, a hitting time information corresponding to the hitting coordinate 604 may be determined. A plurality of corresponding video frames may be determined from the ball game video 602 based on the hitting time information, and a corresponding hitting posture 606 of the motion subject may be extracted from the plurality of video frames. A statistical analysis may be performed based on the at least one hitting posture 606, the at least one hitting coordinate 604, and the at least one landing coordinate 605, to obtain a motion analysis result 607.

Optionally, by using a transformation matrix, the obtained at least one hitting coordinate and at least one landing coordinate may be mapped to actual positions in the playing field to obtain at least one hitting position and at least one landing position. A real-time statistical analysis may be performed based on the at least one hitting posture, the at least one hitting position, and the at least one landing position to obtain a real-time motion analysis result. Alternatively, with matches or rallies as analysis units, it is also possible to perform a statistical analysis on at least one hitting posture, at least one hitting position, and at least one landing position in an analysis unit, to obtain a motion analysis result on a per-unit basis.

According to embodiments of the present disclosure, by integrating visual recognition and artificial intelligence technologies, the accuracy and efficiency of data acquisition may be effectively improved, ensuring that every detail of athlete's training may be precisely captured and analyzed, which is not only crucial for optimizing athlete's training and competition strategies, but also provides more detailed and reliable data support for coaches. By using the method in embodiments of the present disclosure, user experience may be effectively improved, and automated data recording and real-time analysis functions reduce user's dependence on professional knowledge, thereby allowing even non-professionals to easily use the product, which broadens the market applicability of the product. In addition, through real-time feedback and analysis, users may promptly adjust training methods and effectively improve training effects, which increases the attractiveness and market competitiveness of the product.

FIG. 7 schematically shows a block diagram of an apparatus for analyzing a ball game motion according to an embodiment of the present disclosure.

As shown in FIG. 7, an apparatus 700 for analyzing a ball game motion includes a first processing module 710, a first determination module 720, and a second processing module 730.

The first processing module 710 is configured to, in response to entering a serving stage, obtain a motion trajectory of a ball by fitting based on a ball game video acquired.

The first determination module 720 is configured to determine a hitting coordinate of a motion subject, a hitting posture of the motion subject, and a landing coordinate of the ball based on the motion trajectory and the ball game video.

The second processing module 730 is configured to obtain a motion analysis result based on the hitting coordinate, the hitting posture, and the landing coordinate, to display the motion analysis result in real time through a display device.

According to an embodiment of the present disclosure, the ball game video includes a plurality of video frames.

According to an embodiment of the present disclosure, the first processing module 710 includes a first processing sub-module and a second processing sub-module.

The first processing sub-module is configured to perform a position correction on an initial ball coordinate of the video frame to obtain a target ball coordinate of the video frame.

The second processing sub-module is configured to perform a curve fitting based on the respective target ball coordinates of the plurality of video frames to obtain the motion trajectory of the ball.

According to an embodiment of the present disclosure, the first processing sub-module includes a first processing unit, a second processing unit, and a third processing unit.

The first processing unit is configured to determine a plurality of first target video frames associated with the video frame from the ball game video.

The second processing unit is configured to determine a fitted ball coordinate of the video frame based on the respective ball coordinates of the plurality of first target video frames, where the ball coordinate of the first target video frame includes an initial ball coordinate or a target ball coordinate of the first target video frame.

The third processing unit is configured to obtain the target ball coordinate of the video frame based on the fitted ball coordinate and the initial ball coordinate of the video frame.

According to an embodiment of the present disclosure, the second processing unit includes a first processing sub-unit and a second processing sub-unit.

The first processing sub-unit is configured to perform a quadratic curve fitting based on the respective ball coordinates of the plurality of first target video frames to obtain a fitted curve.

The second processing sub-unit is configured to determine the fitted ball coordinate of the video frame based on the fitted curve.

According to an embodiment of the present disclosure, the third processing unit includes a third processing sub-unit and a fourth processing sub-unit.

The third processing sub-unit is configured to calculate a distance between the initial ball coordinate of the video frame and the target ball coordinate of an adjacent video frame to obtain a first distance, where the adjacent video frame is a previous video frame of the video frame in the ball game video.

The fourth processing sub-unit is configured to determine the fitted ball coordinate of the video frame as the target ball coordinate of the video frame if the first distance is greater than a first predetermined threshold.

According to an embodiment of the present disclosure, the third processing unit includes a fifth processing sub-unit and a sixth processing sub-unit.

The fifth processing sub-unit is configured to calculate a distance between the fitted ball coordinate of the video frame and the initial ball coordinate of the video frame to obtain a second distance.

The sixth processing sub-unit is configured to determine the fitted ball coordinate of the video frame as the target ball coordinate of the video frame if the second distance is greater than a second predetermined threshold.

According to an embodiment of the present disclosure, the first processing unit includes a seventh processing sub-unit and an eighth processing sub-unit.

The seventh processing sub-unit is configured to select a first predetermined number of video frames preceding the video frame from the ball game video to obtain a plurality of first target video frames.

The eighth processing sub-unit is configured to select a second predetermined number of video frames subsequent to the video frame from the ball game video to obtain a plurality of first target video frames.

According to an embodiment of the present disclosure, the first processing module 710 further includes a third processing sub-module and a fourth processing sub-module.

The third processing sub-module is configured to perform an object detection on the video frame to obtain a first bounding box in the video frame.

The fourth processing sub-module is configured to obtain the initial ball coordinate of the video frame based on a center point of the first bounding box.

According to an embodiment of the present disclosure, the first determination module 720 includes a first determination sub-module and a second determination sub-module.

The first determination sub-module is configured to determine the hitting coordinate of the motion subject and the landing coordinate of the ball based on trough positions of the motion trajectory.

The second determination sub-module is configured to determine the hitting posture of the motion subject from the ball game video based on a hitting time information corresponding to the hitting coordinate.

According to an embodiment of the present disclosure, the second determination sub-module includes a first determination unit and a second determination unit.

The first determination unit is configured to determine a plurality of second target video frames from the ball game video based on the hitting time information corresponding to the hitting coordinate.

The second determination unit is configured to determine the hitting posture of the motion subject based on the plurality of second target video frames.

According to an embodiment of the present disclosure, the second determination unit includes a first determination sub-unit and a second determination sub-unit.

The first determination sub-unit is configured to input the plurality of second target video frames into a human posture detection model to detect, using the human posture detection model, a plurality of joint key points of the motion subject contained in the plurality of second target video frames, to obtain a detection result.

The second determination sub-unit is configured to determine an action category for a current posture of the motion subject based on the detection result, to obtain the hitting posture of the motion subject.

According to an embodiment of the present disclosure, the second determination unit includes a third determination sub-unit, a fourth determination sub-unit, a fifth determination sub-unit, and a sixth determination sub-unit.

The third determination sub-unit is configured to generate a plurality of joint key point trajectories based on the plurality of joint key points of the motion subject contained in the plurality of second target video frames.

The fourth determination sub-unit is configured to construct an action model based on the plurality of joint key point trajectories.

The fifth determination sub-unit is configured to compare the action model with respective reference action models of a plurality of action categories to obtain comparison results.

The sixth determination sub-unit is configured to determine an action category for a current posture of the motion subject based on the comparison results, to obtain the hitting posture of the motion subject.

According to an embodiment of the present disclosure, the first determination sub-module includes a third determination unit, a fourth determination unit, and a fifth determination unit.

The third determination unit is configured to divide the motion trajectory into a plurality of trajectory segments based on a trajectory extension direction information of the motion trajectory.

The fourth determination unit is configured to determine the landing coordinate of the ball based on a position information of a first trough in the trajectory segment.

The fifth determination unit is configured to determine the hitting coordinate of the motion subject based on a position information of a second trough in the trajectory segment.

According to an embodiment of the present disclosure, the apparatus 700 for analyzing a ball game motion further includes an acquisition module and a detection module.

The acquisition module is configured to acquire an initial motion video.

The detection module is configured to perform a stage detection based on the initial motion video to obtain a detection result, where the detection result indicates whether the serving stage has begun.

According to an embodiment of the present disclosure, the detection module includes a first detection unit, a second detection unit, a third detection unit, and a fourth detection unit.

The first detection unit is configured to perform an object detection on the initial motion video to obtain a second bounding box of the motion subject in the initial motion video.

The second detection unit is configured to obtain an image coordinate of the motion subject based on a center point of a bottom surface of the second bounding box.

The third detection unit is configured to map the image coordinate of the motion subject to a playing field based on a transformation matrix to obtain a position information of the motion subject, where the position information of the motion subject includes a first position information of a serving motion subject and a second position information of a receiving motion subject.

The fourth detection unit is configured to obtain a detection result indicating that the serving stage has begun if, in a plurality of consecutive third target video frames in the initial motion video, each first position information indicates a position in a serving area of the playing field and each second position information indicates a position in a receiving area of the playing field.

According to an embodiment of the present disclosure, the second processing module 730 includes a fifth processing sub-module and a sixth processing sub-module.

The fifth processing sub-module is configured to map the hitting coordinate and the landing coordinate to a playing field based on a transformation matrix to obtain a hitting position of the motion subject and a landing position of the ball.

The sixth processing sub-module is configured to perform a statistical analysis based on the hitting position, the hitting posture, and the landing position to obtain the motion analysis result.

According to an embodiment of the present disclosure, the apparatus 700 for analyzing a ball game motion further includes a second determination module and a transformation module.

The second determination module is configured to determine a first position of an intersection point of boundary lines of the playing field in the playing field and a second position of the intersection point of boundary lines in the ball game video.

The transformation module is configured to perform a homography transformation based on the first position and the second position to obtain the transformation matrix.

According to an embodiment of the present disclosure, the apparatus 700 for analyzing a ball game motion further includes a stitching module.

The stitching module is configured to obtain the ball game video based on videos respectively captured by a plurality of cameras, where a target field of view covers the playing field is obtained by combining respective fields of view of the plurality of cameras.

According to an embodiment of the present disclosure, the stitching module includes a first stitching unit, a second stitching unit, a third stitching unit, a fourth stitching unit, and a fifth stitching unit.

The first stitching unit is configured to acquire a plurality of first videos respectively captured by the plurality of cameras.

The second stitching unit is configured to perform a timestamp alignment on the plurality of first videos to obtain a plurality of second videos.

The third stitching unit is configured to perform a distortion correction on the plurality of second videos to obtain a plurality of third videos.

The fourth stitching unit is configured to perform a calibration on the plurality of third videos based on respective extrinsic parameters of the plurality of cameras, using the intersection point of boundary lines of the playing field as a calibration target, to obtain a plurality of fourth videos.

The fifth stitching unit is configured to stitch the plurality of fourth videos to obtain the ball game video.

According to embodiments of the present disclosure, the present disclosure further provides an electronic device, a readable storage medium, and a computer program product.

According to an embodiment of the present disclosure, an electronic device is provided, including: at least one processor; and a memory communicatively connected to the at least one processor. The memory stores instructions executable by the at least one processor, and the instructions are configured to, when executed by the at least one processor, cause the at least one processor to implement the method described above.

According to an embodiment of the present disclosure, a non-transitory computer-readable storage medium having computer instructions therein is provided, and the computer instructions are configured to cause a computer to implement the method described above.

According to an embodiment of the present disclosure, a computer program product containing a computer program is provided, and the computer program is configured to, when executed by a processor, implement the method described above

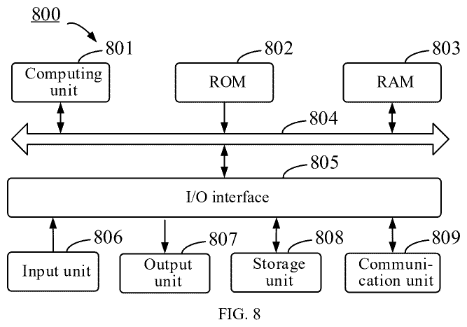

FIG. 8 shows a schematic block diagram of an example electronic device that may be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and processes described above, such as the method for analyzing a ball game motion. For example, in some embodiments, the method for analyzing a ball game motion may be implemented as a computer software program which is tangibly embodied in a machine-readable medium, such as the storage unit 8012. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method for analyzing a ball game motion described above. Alternatively, in other embodiments, the computing unit 801 may be used to perform the method for analyzing a ball game motion by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method for analyzing a ball game motion of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for analyzing a ball game motion, comprising:
in response to entering a serving stage, obtaining a motion trajectory of a ball by fitting based on a ball game video acquired;
determining a hitting coordinate of a motion subject, a hitting posture of the motion subject, and a landing coordinate of the ball based on the motion trajectory and the ball game video; and
obtaining a motion analysis result based on the hitting coordinate, the hitting posture, and the landing coordinate, to display the motion analysis result in real time through a display device.

2. The method of claim 1, wherein the ball game video comprises a plurality of video frames, and the obtaining a motion trajectory of a ball by fitting based on a ball game video acquired comprises:
performing a position correction on an initial ball coordinate of a video frame to obtain a target ball coordinate of the video frame; and
performing curve fitting based on the respective target ball coordinates of the plurality of video frames to obtain the motion trajectory of the ball.

3. The method of claim 2, wherein the performing a position correction on an initial ball coordinate of a video frame to obtain a target ball coordinate of the video frame comprises:
determining a plurality of first target video frames associated with the video frame from the ball game video;
determining a fitted ball coordinate of the video frame based on respective ball coordinates of the plurality of first target video frames, wherein the ball coordinate of the first target video frame comprises an initial ball coordinate or a target ball coordinate of the first target video frame; and
obtaining the target ball coordinate of the video frame based on the fitted ball coordinate and the initial ball coordinate of the video frame.

4. The method of claim 3, wherein the determining a fitted ball coordinate of the video frame based on respective ball coordinates of the plurality of first target video frames comprises:
performing quadratic curve fitting based on the respective ball coordinates of the plurality of first target video frames to obtain a fitted curve; and
determining the fitted ball coordinate of the video frame based on the fitted curve.

5. The method of claim 3, wherein the obtaining the target ball coordinate of the video frame based on the fitted ball coordinate and the initial ball coordinate of the video frame comprises:
calculating a distance between the initial ball coordinate of the video frame and the target ball coordinate of an adjacent video frame to obtain a first distance, wherein the adjacent video frame is a previous video frame of the video frame in the ball game video; and
determining the fitted ball coordinate of the video frame as the target ball coordinate of the video frame if the first distance is greater than a first predetermined threshold.

6. The method of claim 3, wherein the obtaining the target ball coordinate of the video frame based on the fitted ball coordinate and the initial ball coordinate of the video frame comprises:
calculating a distance between the fitted ball coordinate of the video frame and the initial ball coordinate of the video frame to obtain a second distance; and
determining the fitted ball coordinate of the video frame as the target ball coordinate of the video frame if the second distance is greater than a second predetermined threshold.

7. The method of claim 3, wherein the determining a plurality of first target video frames associated with the video frame from the ball game video comprises one of:
selecting, from the ball game video, a first predetermined number of video frames preceding the video frame as the plurality of first target video frames;
selecting, from the ball game video, a second predetermined number of video frames subsequent to the video frame as the plurality of first target video frames.

8. The method of claim 2, further comprising:
performing an object detection on the video frame to obtain a first bounding box in the video frame; and
obtaining the initial ball coordinate of the video frame based on a center point of the first bounding box.

9. The method of claim 1, wherein the determining a hitting coordinate of a motion subject, a hitting posture of the motion subject, and a landing coordinate of the ball based on the motion trajectory and the ball game video comprises:
determining the hitting coordinate of the motion subject and the landing coordinate of the ball based on trough positions in the motion trajectory; and
determining the hitting posture of the motion subject from the ball game video based on a hitting time information corresponding to the hitting coordinate.

10. The method of claim 9, wherein the determining the hitting posture of the motion subject from the ball game video based on a hitting time information corresponding to the hitting coordinate comprises:
determining a plurality of second target video frames from the ball game video based on the hitting time information corresponding to the hitting coordinate; and
determining the hitting posture of the motion subject based on the plurality of second target video frames.

11. The method of claim 10, wherein the determining the hitting posture of the motion subject based on the plurality of second target video frames comprises:
inputting the plurality of second target video frames into a human posture detection model to detect, using the human posture detection model, a plurality of joint key points of the motion subject respectively contained in the plurality of second target video frames, to obtain a detection result; and
determining an action category for a current posture of the motion subject based on the detection result, to obtain the hitting posture of the motion subject.

12. The method of claim 10, wherein the determining the hitting posture of the motion subject based on the plurality of second target video frames comprises:
generating a plurality of joint key point trajectories based on a plurality of joint key points of the motion subject respectively contained in the plurality of second target video frames;
constructing an action model based on the plurality of joint key point trajectories;
comparing the action model with respective reference action models of a plurality of action categories to obtain comparison results; and
determining an action category for a current posture of the motion subject based on the comparison results, to obtain the hitting posture of the motion subject.

13. The method of claim 9, wherein the determining the hitting coordinate of the motion subject and the landing coordinate of the ball based on trough positions in the motion trajectory comprises:
dividing the motion trajectory into a plurality of trajectory segments based on a trajectory extension direction information of the motion trajectory;
determining the landing coordinate of the ball based on a position information of a first trough in the trajectory segment; and
determining the hitting coordinate of the motion subject based on a position information of a second trough in the trajectory segment.

14. The method of claim 1, further comprising:
acquiring an initial motion video; and
performing a stage detection based on the initial motion video to obtain a detection result, wherein the detection result indicates whether the serving stage has begun.

15. The method of claim 14, wherein the performing a stage detection based on the initial motion video to obtain a detection result comprises:
performing an object detection on the initial motion video to obtain a second bounding box of the motion subject in the initial motion video;
obtaining an image coordinate of the motion subject based on a center point of a bottom surface of the second bounding box;
mapping the image coordinate of the motion subject to a playing field based on a transformation matrix to obtain a position information of the motion subject, wherein the position information of the motion subject comprises a first position information of a serving motion subject and a second position information of a receiving motion subject; and
obtaining a detection result indicating that the serving stage has begun if, in a plurality of consecutive third target video frames in the initial motion video, each first position information indicates a position in a serving area of the playing field and each second position information indicates a position in a receiving area of the playing field.

16. The method of claim 1, wherein the obtaining a motion analysis result based on the hitting coordinate, the hitting posture, and the landing coordinate comprises:
mapping the hitting coordinate and the landing coordinate to a playing field based on a transformation matrix to obtain a hitting position of the motion subject and a landing position of the ball; and
performing a statistical analysis based on the hitting position, the hitting posture, and the landing position to obtain the motion analysis result.

17. The method of claim 16, further comprising:
determining a first position of an intersection point of boundary lines of the playing field in the playing field and a second position of the intersection point of boundary lines in the ball game video; and
performing a homography transformation based on the first position and the second position to obtain the transformation matrix.

18. The method of claim 1, further comprising:
obtaining the ball game video based on videos respectively captured by a plurality of cameras, wherein a target field of view covers a playing field, and the target field of view is obtained by combining respective fields of view of the plurality of cameras,
wherein the obtaining the ball game video based on videos respectively captured by a plurality of cameras comprises:
acquiring a plurality of first videos respectively captured by the plurality of cameras;
performing a timestamp alignment on the plurality of first videos to obtain a plurality of second videos;
performing a distortion correction on the plurality of second videos to obtain a plurality of third videos;
performing a calibration on the plurality of third videos based on respective extrinsic parameters of the plurality of cameras, using an intersection point of boundary lines of the playing field as a calibration target, to obtain a plurality of fourth videos; and
stitching the plurality of fourth videos to obtain the ball game video.

19. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
in response to entering a serving stage, obtain a motion trajectory of a ball by fitting based on a ball game video acquired;
determine a hitting coordinate of a motion subject, a hitting posture of the motion subject, and a landing coordinate of the ball based on the motion trajectory and the ball game video; and
obtain a motion analysis result based on the hitting coordinate, the hitting posture, and the landing coordinate, to display the motion analysis result in real time through a display device.

20. A non-transitory computer-readable storage medium having computer instructions therein, wherein the computer instructions, when executed by a processor, are configured to cause a computer to:
in response to entering a serving stage, obtain a motion trajectory of a ball by fitting based on a ball game video acquired;
determine a hitting coordinate of a motion subject, a hitting posture of the motion subject, and a landing coordinate of the ball based on the motion trajectory and the ball game video; and
obtain a motion analysis result based on the hitting coordinate, the hitting posture, and the landing coordinate, to display the motion analysis result in real time through a display device.
